(19) United States
(12) Patent Application Publication
(10) Pub. No.: US 2009/0223100 A1
(43) Pub. Date: Sep. 10, 2009

(54) FIGURE EXHIBITING METHOD AND FIGURE EXHIBITING DEVICE

(76) Inventors: Bin-Juine Huang, Taipei (TW); Po-Chien Hsu, Taipei (TW); Min-Sheng Wu, Taipei (TW); Kuo-Yang Chen, Taipei (TW); Yun-Shan Huang, Taipei (TW); Yi-Tin Yen, Taipei (TW)

Correspondence Address: STOUT, UXA, BUYAN & MULLINS LLP, 4 VENTURE, SUITE 300, IRVINE, CA, 92618, US

(21) Appl. No.: 12/099,719

(22) Filed: Apr. 8, 2008

(30) Foreign Application Priority Data
Mar. 7, 2008 (TW) 097108154

(51) Int. Cl. G09F 13/00; A47G 1/06

(52) U.S. Cl. 40/714; 40/728

(57) ABSTRACT

A figure exhibiting method is disclosed in this invention. The figure exhibiting method includes providing a figure and at least one light source. A number of color areas are included in the figure, inga first color area. The light source projects a variety of color lights onto the figure according to a program. The lights include a first light, which is the complementary color of the first color area in order to create a dark visual effect. Alternatively, a color light that is able to create a reflection of color from the first color area can be projected onto the figure, making the color of the area appear differently than it would under sunlight. A figure exhibiting device is also disclosed in this invention. The figure exhibiting device includes a light guiding plate, a transparent plate, a figure and at least one light source. The figure is clipped between the light guiding plate and the transparent plate. The figure includes a number of color areas, particularly, a first color area. The light source is disposed at one side of the light guiding plate and projects a variety of color lights that pass through the light guiding plate to the back surface of the figure, or they can be projected to the front surface via the transparent plate. The lights of different colors include a first light, whose color is the complementary color of the first color area. Alternatively, the first color light can also be a color that is able to make the first color area appear differently than it would under sunlight.

### BACKGROUND OF THE INVENTION

1. Field of the Invention

The present invention generally relates to a figure exhibiting method and a figure exhibiting device, and more particularly to a figure exhibiting method and a figure exhibiting device which use complementary colors or special reflections.

2. Description of the Prior Art

When exhibiting a figure, which can be a painting or a photograph, suitable lights are normally projected onto the figure so as to make the colors of the figure appear the same as when sunlight is projected onto the FIG. 10.

FIG. 1 shows the perspective view of a conventional figure exhibiting method. Included in the FIG. 10 are a first color area 11, a second color area 12 and a third color area 13. The color areas 11, 12 and 13 are of different colors. When exhibiting the FIG. 10, at least one light source 20 projects suitable lights 21 onto the surface of the FIG. 10. When the lights 21 are reflected to an eye 50 of an observer, the observer could notice that the color areas 11, 12, 13 appear to be the same colors as when sunlight is projected onto the FIG. 10.

Although the conventional figure exhibiting method mentioned above allows exhibiting the FIG. 10 in suitable light, the FIG. 10 is only static to the observer's eye 50. The conventional figure exhibiting method is unable to create a dynamic sensation of the FIG. 10 to the observer's eye 50.

Due to the disadvantages of the prior art mentioned above, there exists a need to propose a novel figure exhibiting method and a novel figure exhibiting device which are able to create dynamic visual effects by the lights projected on to the figure.

### SUMMARY OF THE INVENTION

The present invention has been made in order to meet such a need as described above, and it is an object of the present invention to provide a figure exhibiting method and a figure exhibiting device that are able to create dynamic visual effects on the figure by the lights projected.

In order to achieve the above objects, the present invention provides a figure exhibiting method. The figure exhibiting method includes providing a figure and at least one light source. A number of color areas are included in the figure, and among the areas is the first color area. The light source projects a variety of color lights onto the figure as programmed. The lights include a first light, where the color of the first light is the complementary color of the first color area to create a dark visual effect. Alternatively, a color light that is able to create a reflection from the first color area can then be projected onto the figure, making its color appear differently than it would under sunlight. The present invention also provides a figure exhibiting device. The figure exhibiting device includes a light guiding plate, a transparent plate, a figure, and at least one light source. The figure is clipped between the light guiding plate and the transparent plate. Included in the figure are a number of color areas, particularly, a first color area. The light source is disposed at one side of the light guiding plate. A variety of color lights from the light source could pass through the light guiding plate to the back surface of the figure, or they could be projected to the front surface via the transparent plate. The color of the first light is the complementary color of the first color area. Alternatively, a color light can also be used as the first light if it is capable of making the first color area appear different from its color in sunlight.

By using the figure exhibiting method and the figure exhibiting device in the present invention, the figure could give rise to dynamic visual effects with the lights projected onto the figure.

### BRIEF DESCRIPTION OF THE DRAWINGS

FIG. 1 shows the perspective view of a conventional figure exhibiting method;

FIG. 2A shows the perspective view of a figure exhibiting method in accordance with a preferred embodiment of the present invention; and

FIG. 2B and FIG. 2C show the perspective view and the sectional view of a figure exhibiting device in accordance with another preferred embodiment of the present invention.

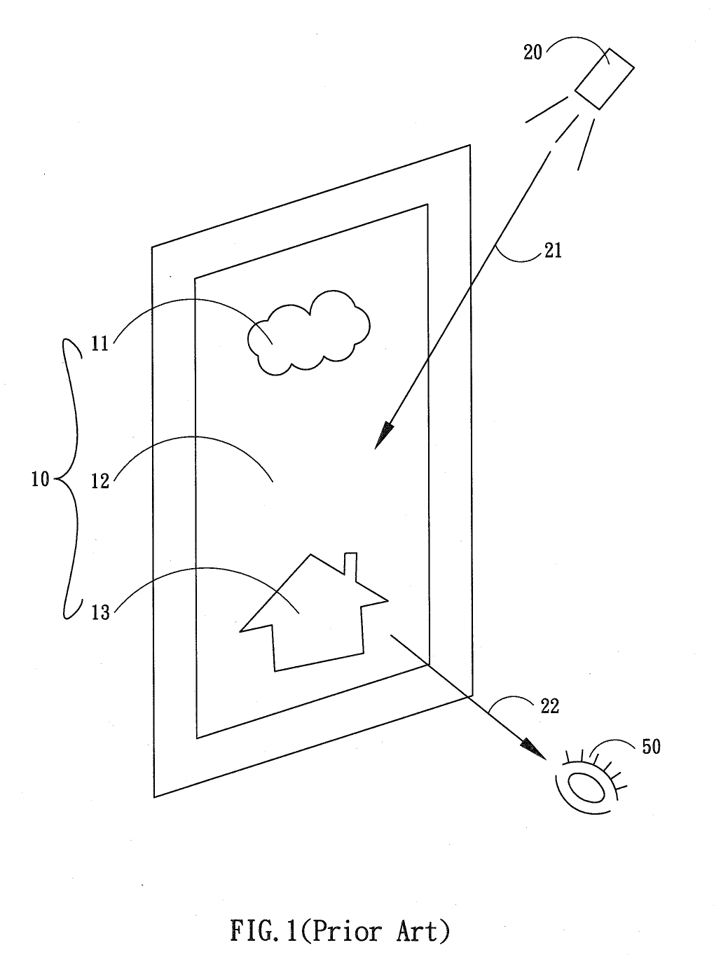

### DETAILED DESCRIPTION OF THE INVENTION

The detailed description of the present invention is discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

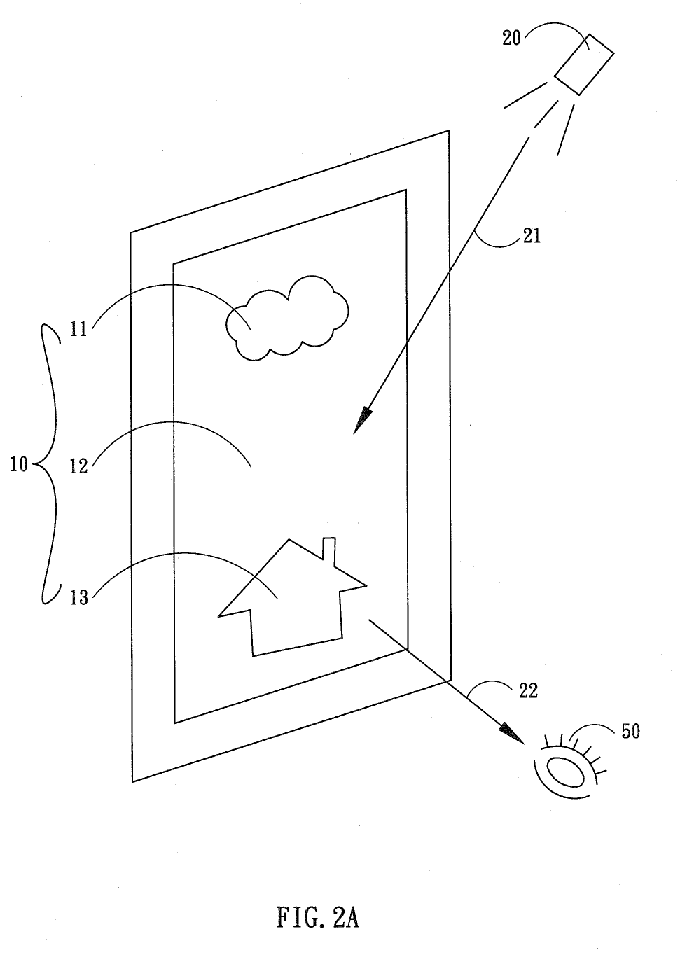

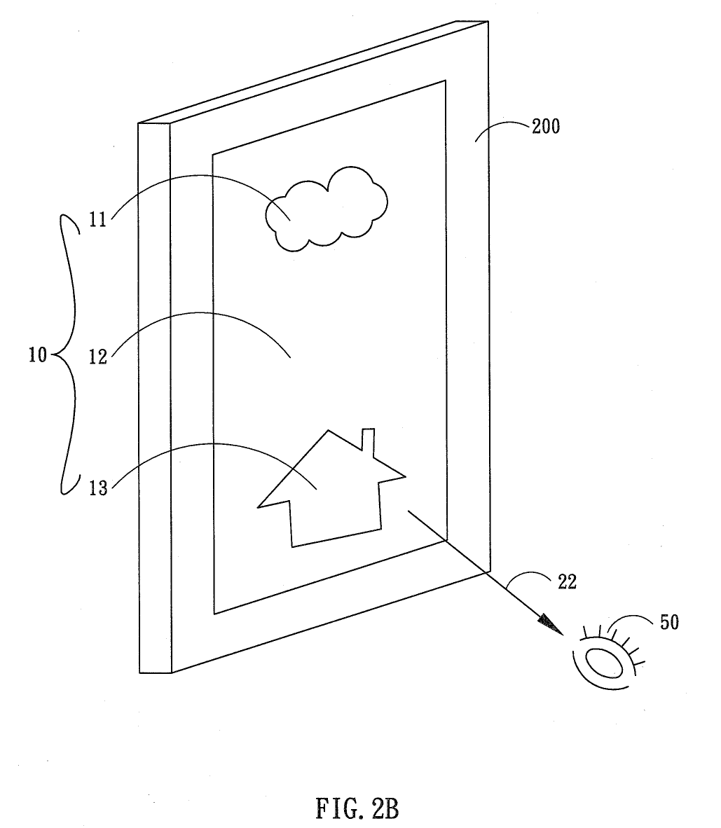

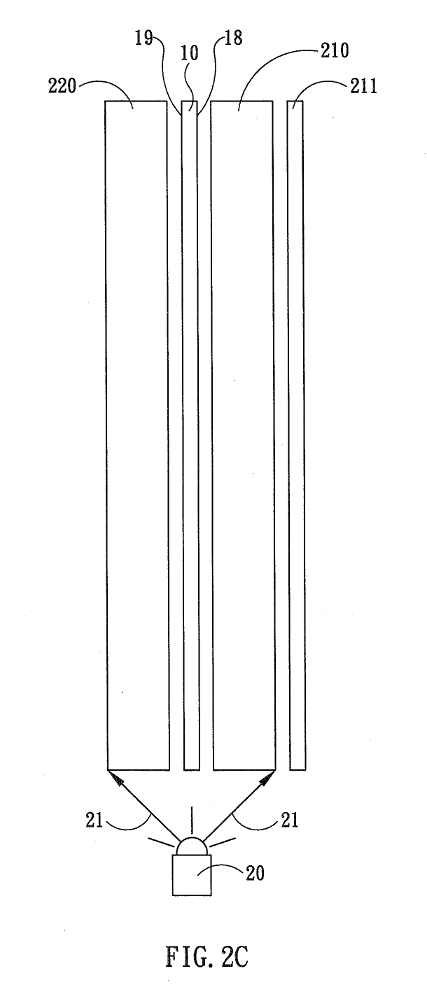

FIG. 2A shows the perspective view of a figure exhibiting method in accordance with a preferred embodiment of the present invention. The figure exhibiting method includes providing a FIG. 10 and at least one light source 20. The FIG. 10 includes a first color area 11, a second color area 12 and a third color area 13. The color areas 11, 12 and 13 are of different colors. The light source 20 projects lights 21 onto the FIG. 10 as programmed. The lights 21 are of different colors, including a first light, a second light and a third light. The color of the first light is the complementary color of the first color area 11; the color of the second light is the complementary color of the second color area 12; the color of the third light is the complementary color of the third color area 13.

When the first light is projected onto the FIG. 10, a dark visual effect is created on the first color area 11, giving the area a black appearance; when the second light is projected onto the FIG. 10, a dark visual effect is created on the second color area 12, giving the area a black appearance; when the third light is projected onto the FIG. 10, a dark visual effect is created on the third color area 13, giving the area a black appearance. With the lights 21 projected serially, the color areas that appear black vary with time. Therefore, the FIG. 10 gives rise to dynamic visual effects with the lights 21 projected onto the FIG. 10. In this embodiment, the FIG. 10 shows a static scene. However, with the lights 21 projected onto the FIG. 10, the FIG. 10 can give rise to different visual effects. For example, the FIG. 10 is able to show a static scene at dawn, at night, in summer, or in winter.

The color of the first light is capable of making the first color area 11 show a dark visual effect so that it appears roughly black; the color of the first light is also capable of making the second color area 12 and the third color area 13 show visual effects such that the colors of the second color area 12 and the third color area 13 appear differently than they would under sunlight. The color of the second light is capable of making the second color area 12 show a dark visual effect such that the second color area 12 appears roughly black; the color of the second light is also capable of making the first color area 11 and the third color area 13 show visual effects such that the color of the first color area 11 and the third color area 13 appear differently than they would under sunlight. The color of the third light is capable of making the third color area 13 show a dark visual effect such that the third color area 13 appears roughly black; the color of the third light is also capable of making the first color area 11 and the second color area 12 show visual effects such that the color of the first color area 11 and the second color area 12 appear differently than they would under sunlight.

According to this embodiment, the light source 20 includes a number of light emitting diodes (LEDs) and a controlling IC. The LEDs include at least one red LED, at least one green LED, and at least one blue LED. The controlling IC controls how the light source 20 projects lights 21 onto the FIG. 10 according to a program. The controlling IC is capable of controlling the power output of each LED in order to produce different colors of lights 21. However, the light source 20 of the present invention is not limited to LED; there are also other suitable light sources that can be used as the light source 20 in the present invention.

FIG. 2B and FIG. 2C show the perspective view and the sectional view of a figure exhibiting device in accordance with another preferred embodiment of the present invention. The figure exhibiting device 200 includes a light guiding plate 210, a transparent plate 220, a FIG. 10, and at least one light source 20. The FIG. 10 is clipped between the light guiding plate 210 and the transparent plate 220. Included in the FIG. 10 are a first color area 11, a second color area 12 and a third color area 13. The color areas 11, 12 and 13 are of different colors. The light source 20 is disposed at one side of the light guiding plate 210 and projects lights 21 onto the FIG. 10. The lights 21 can pass through the light guiding plate 210 to the back surface 18 of the FIG. 10 so as to make the lights 21 penetrate the FIG. 10, or the lights 21 could be projected to the front surface 19 via the transparent plate 220 so as to reflect the lights 21 from the FIG. 10. The lights 21 can be many different colors, including a first light, a second light, and a third light. The color of the first light is the complementary color of the first color area 11; the color of the second light is the complementary color of the second color area 12; the color of the third light is the complementary color of the third color area 13.

When the first light is projected onto the FIG. 10, a dark visual effect is created on the first color area 11, giving the area a black appearance; when the second light is projected onto the FIG. 10, a dark visual effect is created on the second color area 12, giving the area a black appearance; when the third light is projected onto the FIG. 10, a dark visual effect is created on the third color area 13, giving the area a black appearance. When the lights 21 are projected sequentially on to the FIG. 10, the color areas that appear black vary with time, thus creating dynamic visual effects for the FIG. 10. In this embodiment, the FIG. 10 shows a static scene. With the lights 21 being projected on to the FIG. 10, the FIG. 10 can give rise to different visual effects; for example, the FIG. 10 is able to show a static scene at dawn, at night, in the summer, or in the winter.

According to this embodiment, the lights 21 from the light source 20 can be projected to the back surface 18 of the FIG. 10 through the light guiding plate 210, or they can be projected to the front surface 19 of the FIG. 10. Then, lights 21 are reflected to the observer's eye 50 via the transparent plate 220. The transparent plate 220 has the same light guiding function as the light guiding plate 210. The light guiding plate 210 can include a reflecting plate 211 to reflect the lights 21.

According to this embodiment, the light source 20 includes a number of LEDs and a controlling IC. The LEDs include at least one red LED, at least one green LED, and at least one blue LED. The controlling IC controls how the light source 20 project lights 21 onto the FIG. 10 according to a program. The controlling IC is capable of controlling the power output of each LED so as to produce different colors of lights 21. However, the light source 20 of the present invention is not limited to LED; there are also other light sources which are suitable to be used as the light source 20 in the present invention. In this embodiment, the figure exhibiting device 200 can also include a time device (not shown). The time device can function as an alarm clock, and is capable of displaying time. The light source 20 could project lights 21 according to the time of the time device.

By using the figure exhibiting method and the figure exhibiting device of the present invention, the figure can give rise to dynamic visual effects with the lights projected on to the figure.

Although specific embodiments have been illustrated and described, it will be appreciated by those skilled in the arts that various modifications may be made without departing from the scope of the present invention, which is intended to be limited solely by the appended claims.

What is claimed is:

1. A figure exhibiting method, comprising:
providing a figure, said figure comprising a number of color areas, said color areas having different colors, said color areas comprising a first color area; and
providing at least one light source, said light source projecting a variety of lights onto said figure according to a program, said lights having different colors, said lights comprising a first light, the color of said first light being capable of making said color areas appear as different colors from under sunlight, wherein the color of said first light is the complementary color of said first color area.

2. The figure exhibiting method according to claim 1, when said first light is projected onto said figure, said first color area appears black.

3. The figure exhibiting method according to claim 1, wherein said light source comprises a number of LEDs.

4. The figure exhibiting method according to claim 1, wherein said light source comprises at least one red LED, at least one green LED, and at least one blue LED.

5. The figure exhibiting method according to claim 1, wherein said light source comprises a controlling IC so as to control said light source.

6. The figure exhibiting method according to claim 1, wherein said figure is a painting.

7. The figure exhibiting method according to claim 1, wherein said figure is a photograph.

8. A figure exhibiting device, comprising:
a light guiding plate;
a transparent plate;
a figure, said figure being clipped between said light guiding plate and said transparent plate, said figure comprising a number of color areas, said color areas having different colors, said color areas comprising a first color area; and
at least one light source, said light source being disposed at one side of said light guiding plate and said transparent plate, said light source projecting a number of lights onto said figure, said lights having different colors, said lights comprising a first light, the color of said first light being capable of making said color areas appear as different colors from under sunlight, wherein the color of said first light is the complementary color of said first color area.

9. The figure exhibiting device according to claim 8, wherein said lights pass through said transparent plate to a front surface of said figure.

10. The figure exhibiting device according to claim B, wherein said lights pass through said light guiding plate to a back surface of said figure.

11. The figure exhibiting device according to claim 8, further comprising a reflecting plate so as to reflect said lights.

12. The figure exhibiting device according to claim 8, wherein when said first light is projected onto said figure, said first color area appears substantially as a black color.

13. The figure exhibiting device according to claim 8, wherein said light source is comprised of a number of LEDs.

14. The figure exhibiting device according to claim 8, wherein said light source is comprised of at least one red LED, at least one green LED, and at least one blue LED.

15. The figure exhibiting device according to claim 8, wherein said light source is comprised of a controlling IC so as to control said light source.

16. The figure exhibiting device according to claim 8, wherein said figure is a painting.

17. The figure exhibiting device according to claim 8, wherein said figure is a photograph.

18. The figure exhibiting device according to claim 8, further comprising a time device so as to display time.

19. The figure exhibiting device according to claim 8, wherein said light source projects said lights onto said figure according to said time device.
